(19) United States
(12) Patent Application Publication
(10) Pub. No.: US 2013/0236041 A1
(43) Pub. Date: Sep. 12, 2013

(54) BATTERY HOLDER FOR A HEARING DEVICE

(71) Applicant: SIEMENS MEDICAL INSTRUMENTS PTE. LTD., SINGAPORE (SG)

(72) Inventor: UWE FLAIG, FEUCHT (DE)

(73) Assignee: SIEMENS MEDICAL INSTRUMENTS PTE. LTD., SINGAPORE (SG)

(21) Appl. No.: 13/792,624

(22) Filed: Mar. 11, 2013

(30) Foreign Application Priority Data
Mar. 9, 2012 (DE) 10 2012 203 768.3

(51) Int. Cl. H04R 25/00

(52) U.S. Cl. CPC H04R 25/65
USPC 381/323

(57) ABSTRACT

An at least two-piece battery holder is provided for use with a hearing device. The respective individual parts of the battery holder mainly differ here in their material and their material properties. An inner component which is prone to be worn is manufactured from a harder material than a more optically attractive outer component of the battery holder.

### CROSS-REFERENCE TO RELATED APPLICATION

This application claims the priority, under 35 U.S.C. §119, of German application DE 10 2012 203 768.3, filed Mar. 9, 2012; the prior application is herewith incorporated by reference in its entirety.

### BACKGROUND OF THE INVENTION

### Field of the Invention

The invention relates to a battery holder. Furthermore the invention relates to a battery holder for use with a hearing device. A hearing device is to be understood here as any sound-outputting device able to be worn in the ear or on the head, such as a headset, headphones and the like.

One option for the use of hearing devices or wearable hearing apparatuses is to provide hearing assistance to the hard-of-hearing. To meet the numerous individual requirements, different designs of hearing aids, such as behind-the-ear (BTE) devices, hearing devices with an external receiver (RIC: receiver in the canal) and in-the-ear (ITE) hearing devices, e.g. also concha or in-canal hearing devices (ITE, CIC), are provided. The hearing devices given by way of example are worn on the outer ear or in the auditory canal. In addition bone conduction hearing aids, implantable or vibro-tactile hearing aids are also available on the market. In such cases the damaged hearing is stimulated either mechanically or electrically.

Hearing devices basically possess as their major components an input converter, an amplifier and an output converter. The input converter is generally a sound receiver, e.g. a microphone and/or an electromagnetic receiver, e.g. an induction coil. The output converter is mostly realized as an electroacoustic converter, e.g. a miniature loudspeaker, or as an electromechanical converter, e.g. bone-conduction receiver. The amplifier is usually integrated into a signal processing unit, such a signal processing unit is also referred to as a circuit, circuit apparatus or hybrid circuit.

Further components of a hearing device are the battery and the battery holder, which is also referred to as the battery door. Depending on its design, the battery can either be held in the hearing device which is closed off by a battery door as its cover, or the battery is held by the battery holder and moves with the latter. With the first approach it is difficult to remove the battery from the hearing device, therefore the second approach is mainly used nowadays.

A battery door can additionally also fulfill the following requirements: Securing the inserted battery to stop it from accidentally falling out; and switching the hearing device on and off. For this purpose various latching arrangements between the battery door and the hearing device housing are provided in order to hold the battery door in different positions. Because of the switching on and switching off these latching points are prone to wear.

U.S. patent publication No. 2005/0286732 A1 discloses a battery holder for a hearing device which is composed of two parts.

U.S. Pat. No. 6,762,375 B2 discloses an electrical device having a battery compartment with electrical contacts for batteries. A hinged battery holder is disposed on the battery compartment to which a battery can be attached. The battery holder is able to be hinged such that it can swing a battery attached to it into the battery compartment, so that the poles of the battery make contact with the electrical contacts. The hingeable battery holder serves simultaneously as an on and off switch of the electrical device. When the battery is hinged in, the device is switched on, when it is hinged out the device is switched off. In one version the battery compartment is embodied from two parts. These are a rigid cover-type part and a flexible shell-shaped part attached thereto, which are intended to afford the battery a certain freedom of movement.

With frequent switching on and off by hinging the compartment in and out the material of which the battery holder consists wears correspondingly rapidly.

### SUMMARY OF THE INVENTION

It is accordingly an object of the invention to provide a battery holder for a hearing device which overcome the above-mentioned disadvantages of the prior art devices of this general type.

To this end a battery holder for a hearing device is proposed with an outer component and an inner component, characterized in that the inner component consists of a different material then the outer component.

The outer component of the battery holder is attached to the hearing device such that it can be seen from outside. Basically the material of the outer component should therefore be oriented to the rest of the material of the hearing device visible from the outside. In other words, to achieve optical homogeneity, the material of the outer component should match the outer material of the hearing device. On this basis the inner component should be made from a different material with other properties.

A significant element of the solution of the technical objective specified at the outset consists of selecting different materials with different properties for use in a battery holder. The outer component should have an optically attractive appearance. The inner component should be stable and wear-resistant. In addition the inner component has further properties, e.g. springy or elastic, in order for example to fix a button battery in the battery compartment using a form-locking fit.

Advantageously the material of the inner component of the battery holder is harder than the material of the outer component of the battery holder. The inner component is under the greatest mechanically stress, which causes this compartment to wear more. A harder material is more resistant to wear than a softer material. As already mentioned the material of the outer component should match that of an outer shell of the hearing device. On this basis the material of the inner component should be harder even than that of the outer shell or of the outer component. For example a glass fiber reinforced composite substance can serve as material for the inner component.

Advantageously the inner component and the outer component are connected to each other using a form-locking or a force-locking fit. These types of connections cost less than glued connections for example.

Advantageously the battery holder is supported hinged on the battery compartment by a pin support. This is a simple option for hinging the battery holder with the battery in the battery compartment in and out in a hearing device. In an advantageous development the outer component and the inner component are connected to each other by the pin support.

Advantageously a latching or retaining function is available, which allows the inner component of the battery holder to be latched into or held in a battery compartment. In other words the inner component of the battery holder is shaped by a mechanical design such that with a corresponding mating piece, it can latch into the battery compartment of the hearing device. The design of this molding can for example be a projection, e.g. a lug, and the corresponding mating piece can thus be a matching indentation. The inner component is preferably harder and thus tougher than the outer component. It is thus sensible to implement a latching or retaining function that is prone to wear by the harder inner component of the battery holder.

Advantageously the battery holder is embodied so as to accept circular button batteries. This makes it possible to use widely-available standard batteries for hearing devices. These batteries are also referred to as button cells.

In an advantageous development the inner component is designed with an essentially circular cross-section. The outer component surrounds the inner component by at least half the circle circumference of the inner component. In other words the outer component encloses the inner component with a positive fit. This enables inner and outer component to be shaped and disposed such that the inner component cannot be seen from outside the hearing device when the battery compartment is closed.

Advantageously the inner component holds a battery inserted therein by a form-locking and/or force-locking fit. Thus the battery cannot fall out, it is held by the battery holder or by the inner component.

Other features which are considered as characteristic for the invention are set forth in the appended claims.

Although the invention is illustrated and described herein as embodied in a battery holder for a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, exploded perspective view of a battery holder of a hearing device, with inner and outer components according to the invention;

FIG. 2 is a perspective view of the battery holder of the hearing device, with the inner and outer components, in an assembled view;

FIG. 3 is a perspective view of the inner component of the battery holder;

FIG. 4 is a perspective view of the inner component of the battery holder in an alternate view to that shown in FIG. 3;

FIG. 5 is a perspective view of the outer component of the battery holder;

FIG. 6 is a perspective view of the outer component of the battery holder in an alternate view to that shown in FIG. 5;

FIG. 7 is an exploded, perspective view of an alternate embodiment of the battery holder of the hearing device, with the inner and outer components;

FIG. 8 is an exploded, perspective view showing a rotated view of FIG. 7;

FIG. 9 is a perspective view of the components of FIG. 7 and FIG. 8 in the assembled state;

FIG. 10 is a perspective view of the battery holder, with the inner and outer components and a battery, in the assembled state;

FIG. 11 is a perspective view of the inner component of the battery holder with the battery;

FIG. 12 is an exploded, perspective view of the battery holder, with the battery and the inner and outer components; and

FIG. 13 is a perspective view of the hearing device with an opened battery holder.

### DETAILED DESCRIPTION OF THE INVENTION

Two different forms of embodiment are described below. This explicitly does not represent any definitive delimitation to two forms of the embodiment. Further different forms of the embodiment are possible.

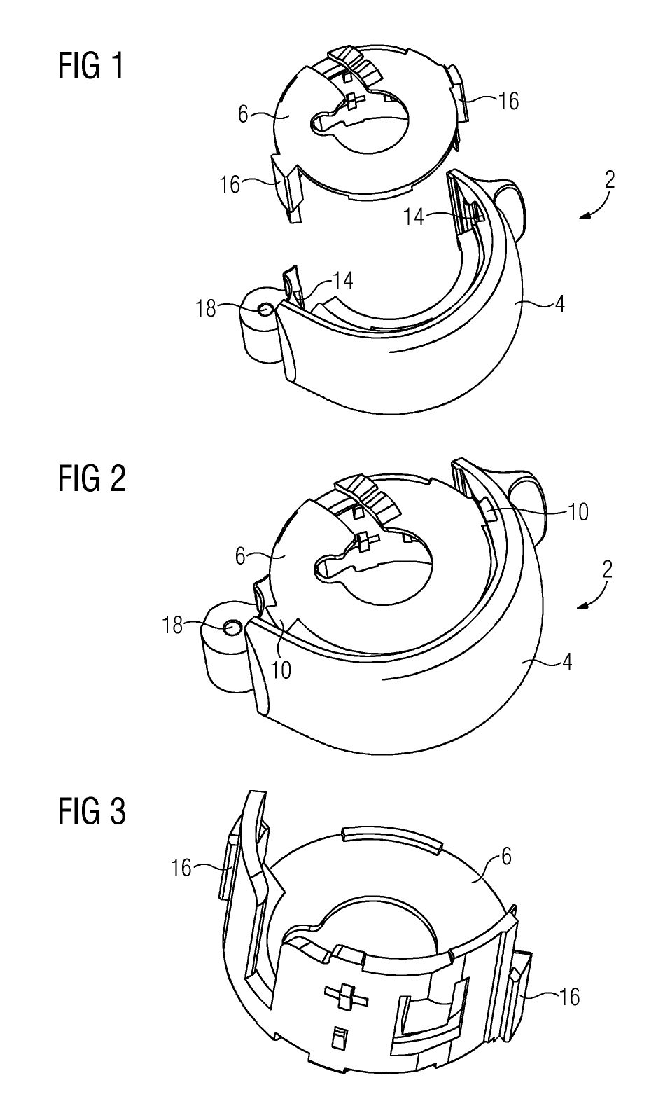

Referring now to the figures of the drawing in detail and first, particularly, to FIG. 1 thereof, there is shown a battery holder 2 for a hearing device with an outer component 4 and an inner component 6. Disposed on the semicircular-shaped outer component 4 is a support element 18. In addition two recesses 14 are located on the inner side of the outer component 4. The two recesses 14 are located in this example opposite one another and have an essentially trapezoidal cross-section. As an alternative they could also have a diamond-shaped cross-section. Corresponding to this cross-section the inner component 6 has essentially trapezoidal overhangs 16. In other words the overhangs 16 and the recesses 14 fit together such that a forming-locking and a force-locking connection of the components can be made with them. The recesses 14 and overhangs 16 recognizably form a form-locking connection, i.e. the inner component 6 and the outer component 4 can only be moved in the direction along the longitudinal extent of the recesses 14 or overhangs 16. In addition a form-locking connection can be created by the recesses 14 gripping the overhangs 16 with an increased force, so that even a movement of the inner component 6 in relation to the outer component 4 in the direction along the longitudinal extent of the recesses 14 or overhangs 16 can only be undertaken by overcoming the force acting as the form-locking connection.

FIG. 2 presents the two separated components of FIG. 1 in the assembled state. Specifically a forming-locking and/or a force-locking connection 10 is shown which results from the assembly of the outer component 4 and the inner component 6. In other words the forming-locking and/or a force-locking fixing of the components 4 and 6 brings about the connection 10.

In FIG. 3 the inner component 6 can be seen in another view. In this version this component essentially contains an annular, flat surface. Attached to its outer edge is the jacket surface which contains approximately half of the outer circumference of the flat surface.

It can be seen from this diagram that the overhangs 16 are disposed on the outer jacket surface. The overhangs 16 are longitudinal and have an almost trapezoidal cross-section.

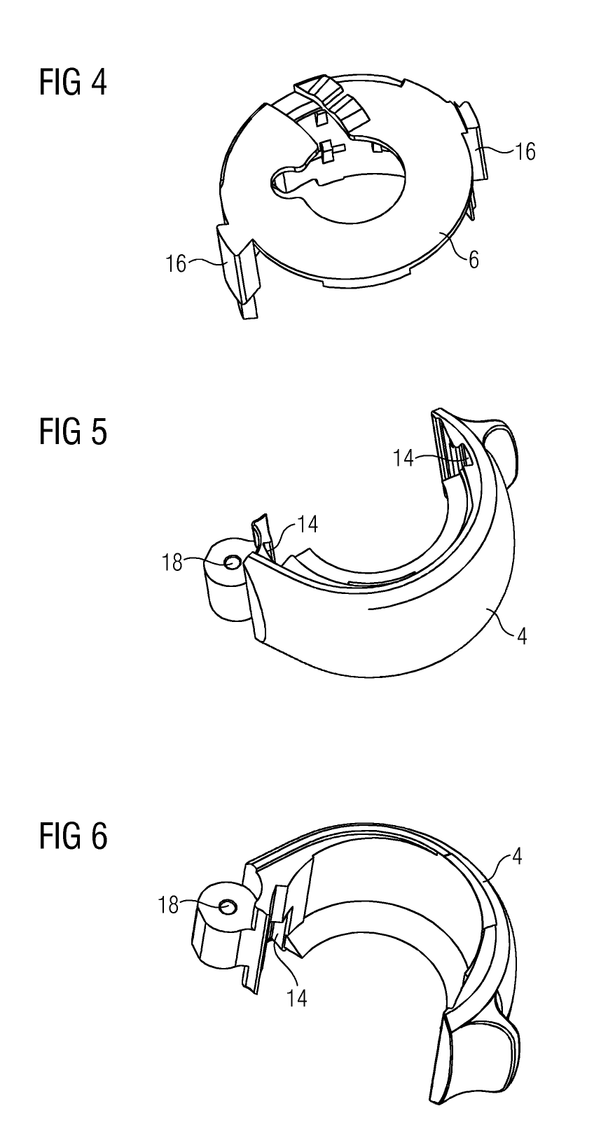

FIG. 4 shows the inner component 6 in a view rotated by 180° compared to FIG. 3. The annular, flat surface can be seen. The overhangs 16, which in this version are flush with the base surface, are also shown.

The outer component 4 is shown on its own in FIG. 5 and FIG. 6. These two figures show views from opposite directions. The outer component 4 in this version is embodied in the shape of a semicircle. The recesses 14 are machined into the outer component 4. In addition the support element 18 is disposed on one end of the semicircular shape. This is embodied with a longitudinal annular cross section. The support element 18 is constructed in this version to be supported by a pin on the hearing device.

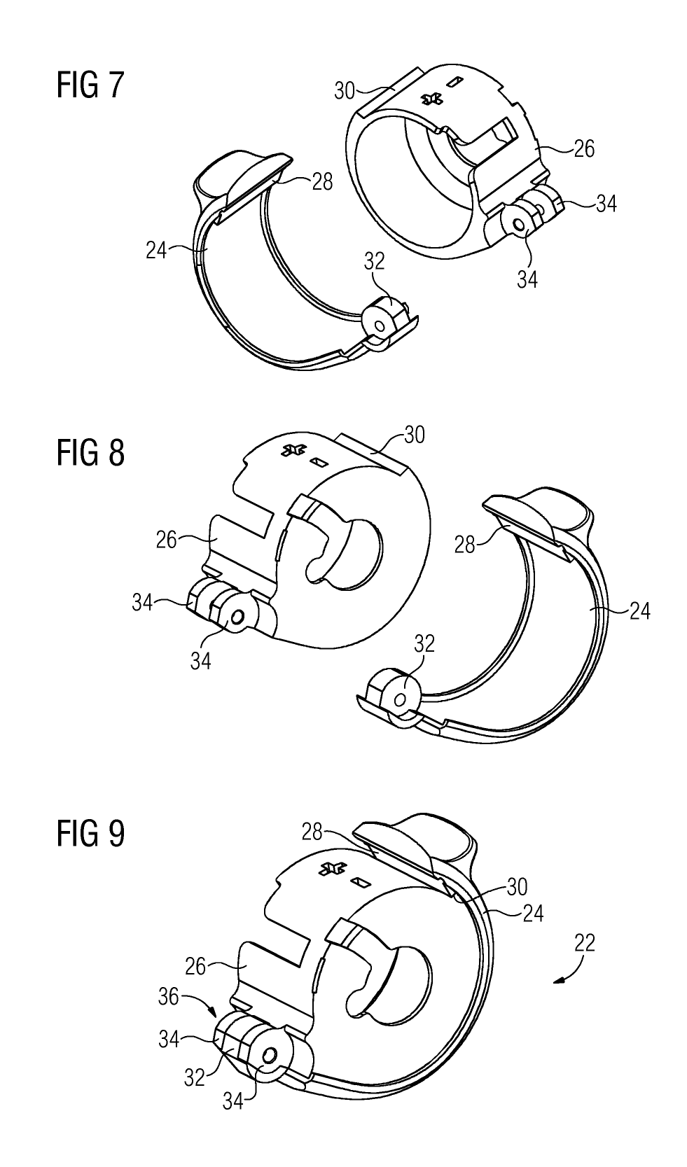

A second embodiment of a battery holder 22 can be seen in FIGS. 7-9. Shown in these figures are an outer component 24 and an inner component 26 in different views. FIG. 7 and FIG. 8 show an exploded diagram, FIG. 9 shows an assembled diagram of the battery holder 22. In this version a forming-locking and/or a force-locking connection of the components is established by a mechanical matching of an outer support element 32 and an inner support element 34. Fixed to the inner component 26 are two annular disks as inner support element 34. These disks are disposed in parallel to one another and spaced apart from one another. Their corresponding mating piece is an outer support element 32, which is fixed to the outer component 24. When assembled the components 24, 26, supplement each other and also the support elements 32, 34, as shown in FIG. 9. The support elements 32 and 34, together with a pin not shown in the figures, produce a support connection 36. By the support connection 36 the battery holder 22 can be disposed supported pivotably or rotatably on a hearing device. The support per se is typically provided by the pin not shown in the figures, which is guided through the hole in the support connection 36. In this way, in addition to the supporting properties, the pin also holds the components 24 and 26 together. In other words a form-locking connection is effected by the support element 34 tensioning the support element 32, the form-locking connection is made by a pin pushed through the elements, which is not shown here.

Furthermore FIGS. 7 to 9 show an outer projection 28 and an inner projection 30. The support connection 36 establishes a form-locking connection by interacting with the outer projection 28 and the corresponding inner projection 30 diametrically opposed to one another in relation to the footprint. Thus the inner component 26 cannot hinge away from the outer component 24 when the battery holder 22 is rotated around the longitudinal axis of the support connection 36.

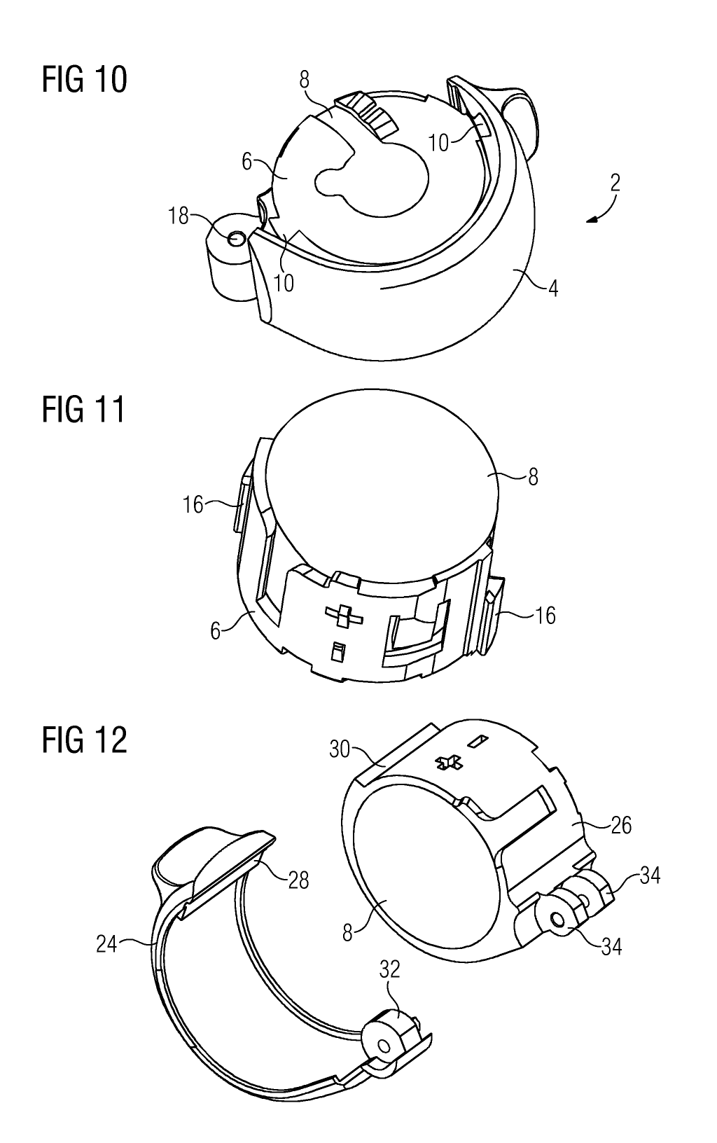

FIGS. 10-12 show the two previously explained forms of embodiment with a battery 8. The battery 8 shown involves a typical button cell battery typical of hearing devices. It can be seen that, depending on the embodiment, the inner components 6, 26 are adapted to the battery shape. The shape or the size of the inner components 6, 26 can vary since, depending on hearing device type, the battery size and shape is different. Consequently the outer components 4, 24 are also adapted to the battery size and the size of the inner components 6, 26.

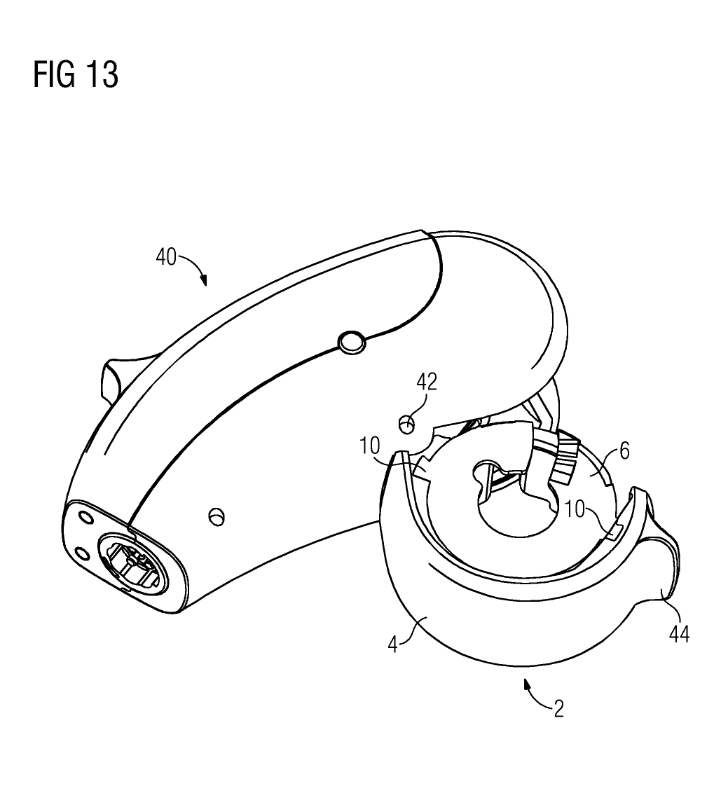

FIG. 13 shows a hearing device 40 with an embodiment of the battery holder 2 supported thereon. The battery holder 2 is composed of the outer component 4 and the inner component 6 in a forming-locking and a force-locking fit. The form-locking fit is affected here by the connection 10, in which the components 4, 6 engage in one another. A form-locking connection is created by the recesses enclosing the overhangs with an increased force in the connection 10, so that even a movement of the inner component 6 in relation to the outer component 4 in a direction along the longitudinal extent of the connection 10 can only be undertaken by overcoming the force acting as the form-locking fit.

The battery holder 2 is supported at a location provided on the hearing device 40 with the previously described support by pin 42. This makes it possible to hinge the battery holder 2 in and out on the hearing device 40. The pin 42 normally involves a metal pin. For example the hearing device could be turned on and off by appropriately hinging in and out. A grip 44 assists the hinging in and out of the battery holder 2. The grip 44 in this version involves a projecting part on the outer side of the battery holder 2 which can be easily operated by a fingertip and assists in hinging the holder in and out.

The outer component 4 of the battery holder 2 is attached to the hearing device 40 such that it is visible from the outside. Therefore the material of the outer component 4 is oriented towards the remaining material of the hearing device 40 visible from the outside. In other words, in order to obtain an optical homogeneity the material of the outer component 4 is manufactured from the same material as the envelope material of the hearing device 40. Based on the material of the outer component 4, the inner component 6 is made from a different, harder material with other properties. For example a glass fiber-reinforced composite substance could serve as the material for the inner component 6.

A form-locking connection is a connection that connects two elements together due to the shape of the elements themselves (e.g. a ball and socket), as opposed to a force-locking connection, which locks the elements together by a force external to the elements (e.g. force from a screw).

1. A battery holder for a hearing device, the battery holder comprising:
an outer component; and
an inner component formed of a different material than said outer component.

2. The battery holder according to claim 1, wherein said inner component has a material that is harder than a material of said outer component.

3. The battery holder according to claim 1, wherein said inner component and said outer component are joined together with at least one of a form-locking connection or a force-locking connection.

4. The battery holder according to claim 1, further comprising a pin support, the battery holder is supported pivotably on a battery compartment of the hearing device by said pin support.

5. The battery holder according to claim 4, wherein said outer component and said inner component are connected to each other by means of said pin support.

6. The battery holder according to claim 1, wherein said inner component is shaped to bring about a latching or retaining function of the battery holder in a battery compartment of the hearing device.

7. The battery holder according to claim 1, wherein the battery holder is embodied to accommodate a circular button battery.

8. The battery holder according to claim 7, wherein said inner component has a circular cross-section and said outer component surrounds said inner component around at least half of said circular cross-section of said inner component.

9. The battery holder according to claim 1, wherein said inner component holds a battery inserted therein by means of at least one of a form-locking or force-locking fit.

10. A hearing device, comprising:
a battery holder having an outer component and an inner component formed of a different material than said outer component.
